(19) United States
(12) Patent Application Publication
(10) Pub. No.: US 2010/0210212 A1
(43) Pub. Date: Aug. 19, 2010

(54) MOBILE COMMUNICATION DEVICE

(75) Inventor: Hiroto SATO, Tachikawa-shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KABUSHIKI KAISHA TOSHIBA, Tokyo (JP)

(21) Appl. No.: 12/636,982

(22) Filed: Dec. 14, 2009

(30) Foreign Application Priority Data
Feb. 16, 2009 (JP) 2009-032809

(51) Int. Cl. H04B 7/00

(52) U.S. Cl. 455/41.3

(57) ABSTRACT

A mobile communication device includes: a first communication module configured to perform first wireless communication with a base station; a second communication module configured to perform second wireless communication with a hands-free device through a near field communication network; a power controller configured to supply power to the second communication module when an incoming signal is received from the base station; and a link controller configured to control the second communication module to establish a wireless link with the hands-free device after the power is supplied to the second communication module by the power controller, wherein the power controller maintains supplying the power to the second communication module when the wireless link is established by the link controller and stops supplying the power to the second communication module when the wireless link is unestablished by the link controller.

### CROSS REFERENCE TO RELATED APPLICATION(S)

The present disclosure relates to the subject matters contained in Japanese Patent Application No. 2009-032809 filed on Feb. 16, 2009, which are incorporated herein by reference in its entirety.

### FIELD

The present invention relates to a mobile communication device capable of performing near field communication.

### BACKGROUND

As is known, mobile communication devices perform near field communication using a communication scheme called Bluetooth (registered trademark), with a hands-free voice communication device of a headset type or an in-vehicle type like a car navigation system. In general, the above-described mobile communication devices have a radio module for performing the near-field radio using Bluetooth®. However, since wireless communication using the near-field radio is performed according to need, it is not preferable to constantly operate the radio module from the point of view of power consumption of the mobile communication devices.

As a technology considering such a background, for example, there is known a technology of preventing useless power consumption by stopping a near field communication module when a mobile communication device is outside a car and by operating the near field communication module when the mobile communication device moves inside the car.

An example of such technique is disclosed in a publication JP-A-2005-268933.

However, a technique disclosed in the publication JP-A-2005-268933 has a problem in that power is consumed even when the near field communication module is not used since the near field communication module is operated in the case where the mobile communication device is in the car.

### SUMMARY

One of objects of the present invention is to provide a mobile communication device that performs near field communication when near field communication is required.

According to an aspect of the present invention, there is provided a mobile communication device including: a first communication module configured to perform first wireless communication with a base station; a second communication module configured to perform second wireless communication with a hands-free voice communication device through a near field communication network; a power controller configured to supply power to the second communication module when an incoming signal is received from the base station; and a link controller configured to control the second communication module to establish a wireless link with the hands-free voice communication device after the power is supplied to the second communication module by the power controller, wherein the power controller maintains supplying the power to the second communication module when the wireless link is established by the link controller and stops supplying the power to the second communication module when the wireless link is unestablished by the link controller.

According to another aspect of the present invention, there is provided a mobile communication device including: a first communication module configured to perform first wireless communication with a base station; a second communication module configured to perform second wireless communication with a first hands-free voice communication device and a second hands-free voice communication device through a near field communication network; a link controller configured to control the second communication module to establish a wireless link with one of the first hands-free voice communication device and the second hands-free voice communication device; a characteristic quantity storage configured to store a first characteristic quantity indicating that the incoming signal should preferably be transmitted to the first hands-free voice communication device; a characteristic quantity calculation module configured to calculate a second characteristic quantity from input ambient sound; a characteristic quantity comparison module configured to compare the second characteristic quantity with the first characteristic quantity; and a power controller configured to supply power to the characteristic quantity calculation module, the characteristic quantity comparison module, and the second communication module upon receipt of the incoming signal from the base station.

According to still another aspect of the present invention, there is provided a method for controlling a mobile communication device having: a first communication module configured to perform first wireless communication with a base station; and a second communication module configured to perform second wireless communication with a hands-free voice communication device through a near field communication network, wherein the method including: supplying power to the second communication module when an incoming signal is received from the base station; controlling the second communication module to establish a wireless link with the hands-free voice communication device after the power is supplied to the second communication module; controlling to maintain supplying the power to the second communication module when the wireless link is established and to stop supplying the power to the second communication module when the wireless link is unestablished.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a block diagram showing a configuration of a hands-free voice communication system including a mobile communication device according to an embodiment of the present invention.

FIG. 2 is a block diagram showing a configuration of the mobile communication device according to an embodiment of the present invention.

FIG. 3 is a block diagram showing a configuration of a headset hands-free device according to an embodiment of the present invention.

FIG. 4 is a block diagram showing a configuration of an in-vehicle hands-free device according to an embodiment of the present invention.

FIG. 5 is a diagram showing an example of a configuration of a device list according to an embodiment of the present invention.

FIG. 6 is a flowchart of a control operation of near field communication of a near field communication control function according to an embodiment of the present invention (a control operation when an incoming signal is sent to a controller).

### DETAILED DESCRIPTION OF THE EMBODIMENTS

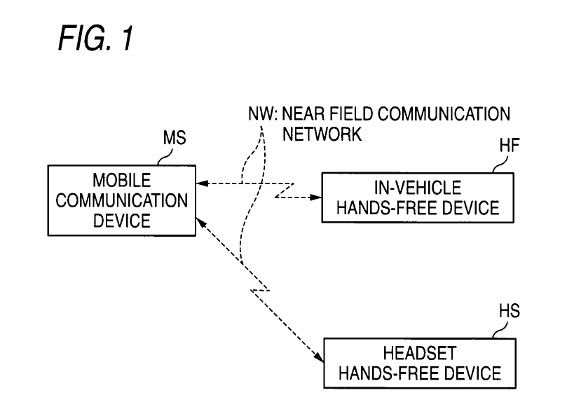

Hereinafter, an embodiment of a mobile communication device according to an embodiment of the present invention will be described with reference to the drawings. FIG. 1 is a block diagram showing a configuration of a hands-free voice communication system using a mobile communication device such as a portable telephone or the like according to an embodiment of the present invention.

The hands-free voice communication system includes, for example, a headset hands-free device HS and an in-vehicle hands-free device HF of a car navigation system or the like to perform near field communication with a mobile communication device MS through a near field communication network NW as well as the mobile communication device MS. The near field communication network NW is assumed to be a communication network using a communication scheme called Bluetooth®. In this regard, the communication scheme is not limited to Bluetooth®, and may use a wireless LAN scheme or an infrared communication scheme.

The mobile communication device MS has a function of performing voice communication with a communication device such as another portable telephone or a fixed telephone through a base station of a mobile communication network and reproducing music contents or multimedia contents downloaded from a content server through the mobile communication network. On the other hand, the in-vehicle hands-free device HF and the headset hands-free device HS can receive incoming signal information through the mobile communication network and the mobile communication device MS by establishing a wireless link with the mobile communication device MS through the near field communication network NW, and perform hands-free voice communication with a communication device transmitting an outgoing signal when an operation of responding to a notification based on the incoming signal information is performed.

The in-vehicle hands-free device HF and the headset hands-free device HS can receive a voice signal and an audio signal of music contents or multimedia contents reproduced by the mobile communication device MS through the near field communication network NW and output from a speaker. When an external output port (not shown) is provided, the signals can be output from a headphone by connecting the external output port to the headphone.

Hereinafter, the main components of the mobile communication device MS, the in-vehicle hands-free device HF, and the headset hands-free device HS will be described.

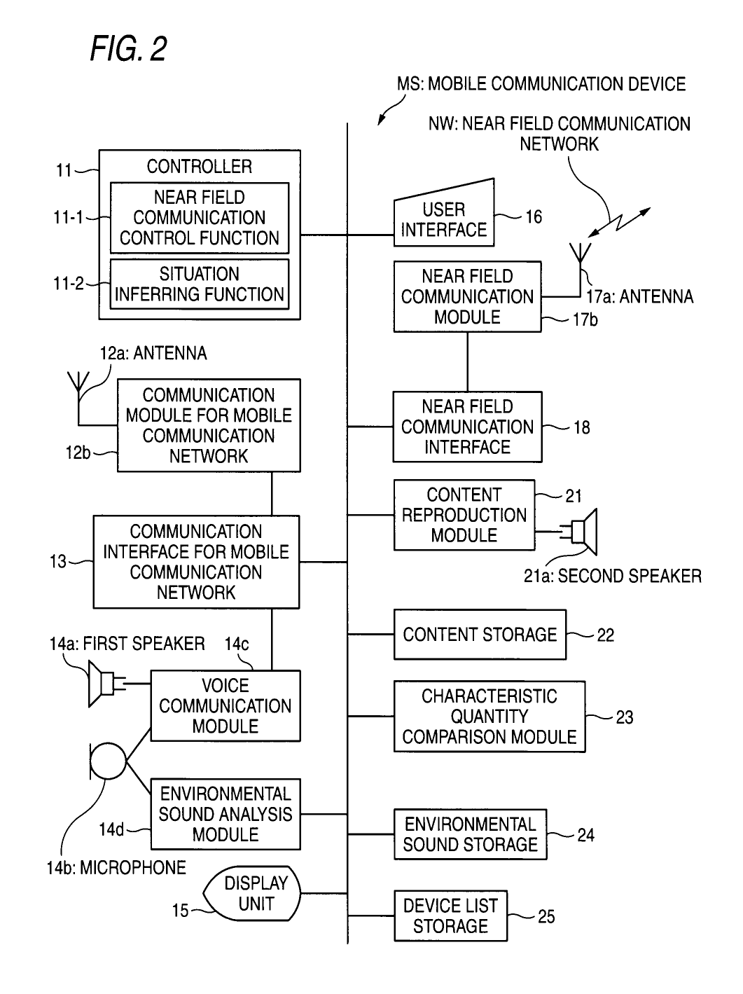

FIG. 2 is a block diagram showing a configuration of the mobile communication device MS according to an embodiment of the present invention. The mobile communication device MS includes a controller 11 that controls the entire device; an antenna 12a that transmits and receives a wireless signal with a base station belonging to a mobile communication network; a communication module 12b for the mobile communication network; a communication interface 13 for the mobile communication network, a first speaker 14a to be mainly used for voice communication; a microphone 14b; a voice communication module 14c; an environmental sound analysis module 14d that analyzes ambient sound; a display unit 15 that displays information to a user; an user interface 16 that allows a user to input an operation instruction of an outgoing signal transmission operation or an incoming signal reception response; an antenna 17a that transmits and receives a near-field wireless signal through the near field communication network NW; a near field communication module 17b; a near field communication interface 18; a content reproduction module 21 having an AAC decoding function for decoding, for example, AAC encoded audio data, and an H.264 decoding function for decoding, for example, an H.264 encoded image signal; a second speaker 21a to be used to output a voice signal and an audio signal when music contents or multimedia contents are mainly reproduced; a content storage 22; a characteristic quantity comparison module 23; a ambient sound storage 24; and a device list storage 25. Here, the coding scheme is an illustrative example and is not limited to AAC and H.264.

The controller 11 runs programs to realize a near field communication control function 11-1 and a situation inferring function 11-2. The content storage 22 stores music contents or multimedia contents. In the ambient sound storage 24, a characteristic quantity of detected ambient sound when the device is in the car is stored as environmental sound. The device list storage 25 stores a device list including identification information of devices with which the mobile communication device MS performs near field communication through the near field communication network NW.

When a power key as a function key is pressed and a power supply is turned on, the controller 11 controls power supply for each element required to execute each function of the mobile communication device MS. However, in the present invention, the power supply for the near field communication module 17b and the near field communication interface 18 is controlled by the near field communication control function 11-1, and the power supply for the environmental sound analysis module 14b and the characteristic quantity comparison module 23 is controlled by the situation inferring function 11-2.

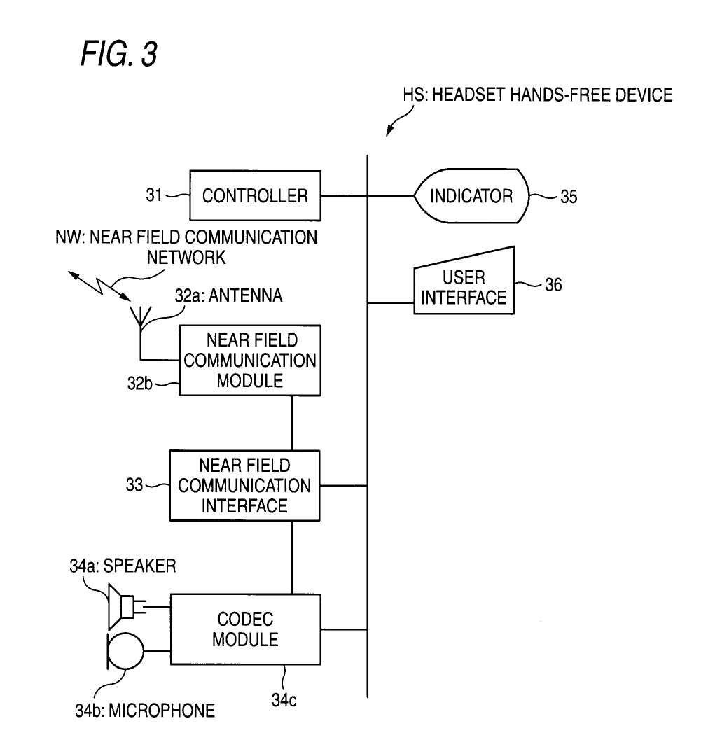

FIG. 3 is a block diagram showing a configuration of the headset hands-free device HS. The headset hands-free device HS includes a controller 31 that controls the entire device; an antenna 32a that transmits and receives a near-field wireless signal through the near field communication network NW; a near field communication module 32b; a near field communication interface 33; a speaker 34a for outputting a voice signal upon voice communication and an audio signal upon reproduction of music contents or multimedia contents; a microphone 34b; a codec module 34c; an indicator 35 that indicates various information; and an user interface 36 including a power key that instructs power ON/OFF and an operation instruction input key such as an operation key for instructing an outgoing signal transmission/incoming signal reception response.

The same device can be considered by providing an external output port in place of the speaker 34a and connecting a headphone to the external output port. In general, the headset hands-free device HS is a device having a battery (not shown) in which power is supplied in accordance with power ON/OFF.

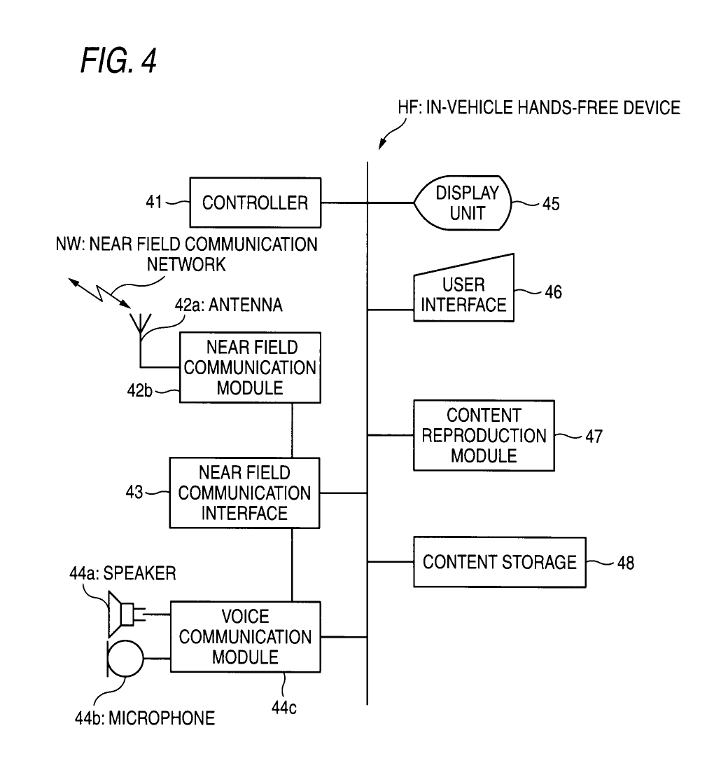

FIG. 4 is a block diagram showing a configuration of the in-vehicle hands-free device HF. The in-vehicle hands-free device HF includes a controller 41 that controls the entire device; an antenna 42a that transmits and receives a near-field wireless signal through the near field communication network NW; a near field communication module 42b; a near field communication interface 43; a speaker 44a for outputting a voice signal upon voice communication and an audio signal upon reproduction of music contents or multimedia contents; a microphone 44b; a voice communication module 44c; a display unit 45 that displays various information; an user interface 46 including a power key for instructing power ON/OFF, an operation key for instructing an outgoing signal transmission/incoming signal reception response, and a plurality of keys for inputting other various instructions; a content reproduction module 47; and a content storage 48 storing music contents or multimedia contents.

Usually, the in-vehicle hands-free device HF is a device integrated with a car navigation system installed in a car. In this case, the power supply for the in-vehicle hands-free device HF is controlled in accordance with an ignition key of the car.

Continuously, the operation of each element of the mobile communication device MS, the in-vehicle hands-free device HF, and the headset hands-free device HS will be described.

First, the operation of each element of the mobile communication device MS will be described with reference to FIG. 2.

The near field communication control function 11-1 selects one of (a) the mobile communication device MS, (b) the in-vehicle hands-free device HF, and (c) the headset hands-free device HS to output a voice signal upon voice communication with a communication device connected through the mobile communication network or voice and audio signals reproduced by the content reproduction module 21. In addition to (a) to (c) described above, an option can be provided to output voice and audio signals by both the mobile communication device MS and the in-vehicle hands-free device HF and by both the mobile communication device MS and the headset hands-free device HS.

Upon selection, the near field communication control function 11-1 refers to a determination result of the situation inferring function 11-2 that determines whether or not the mobile communication device MS is in the car, and whether or not communication with the in-vehicle hands-free device HF and the headset hands-free device HS through the near field communication network NW is available.

When an operation of outputting voice and audio signals by the in-vehicle hands-free device HF or the headset hands-free device HS is selected, the near field communication control function 11-1 controls power to be supplied from the battery to the near field communication module 17b and the near field communication interface 18, thereby enabling near-field communication through the near field communication network NW.

On the other hand, the situation inferring function 11-2 calculates a characteristic quantity based on a voice signal input from the microphone 14b and causes the environmental sound storage 24 to store the calculated characteristic quantity by controlling power supply for the environmental sound analysis module 14d, and causes the characteristic quantity comparison module 23 to compare a characteristic quantity stored in the environmental sound storage 24 with the characteristic quantity calculated by the environmental sound analysis module 14d on the basis of an analog voice signal input from the microphone 14b by controlling the power supply for the environmental sound analysis module 14d and the characteristic quantity comparison module 23.

To store a characteristic quantity in the environmental sound storage 24, the power for the environmental sound analysis module 14d is supplied when the mobile communication device MS exists in the car so as to exclude sound other than ambient sound like the engine sound of the car if available and the in-vehicle hands-free device HF is connected through the near field communication NW, but signal transmission/reception, associated with a sound output of a voice or audio signal, to/from the in-vehicle hands-free device HF is not performed. When an object to be calculated for a characteristic quantity is car-engine operating sound input from the microphone 14b, it is preferable to perform a number of characteristic quantity calculations since the engine sound varies with the number of engine rotations.

Thereafter, when a process of storing the characteristic quantity in the environmental sound storage 24 and a process of comparing the calculated characteristic quantity with a characteristic quantity stored in the environmental sound storage 24 are terminated, the situation inferring function 11-2 stops the power supply for the environmental sound analysis module 14d and the characteristic quantity comparison module 23.

The communication module 12b for the mobile communication network obtains a high-frequency signal from a wireless signal received by the antenna 12a from the base station and then transmits the high-frequency signal to the communication interface 13 for the mobile communication network. A high-frequency signal output from the communication interface 13 for the mobile communication network is transmitted to the antenna 12a.

The communication interface 13 for the mobile communication network amplifies, frequency-converts, and demodulates the high-frequency signal from the communication module 12b for the mobile communication network, thereby transmitting a digital voice signal obtained thereby to the voice communication module 14c or the near field communication interface 18 and transmitting a control signal including an incoming signal to the controller 11. The communication interface 13 modulates, frequency-converts, and amplifies digital voice signals output from the voice communication module 14c and the near field communication interface 18 and a control signal including an outgoing call signal output from the controller 11, thereby obtaining a high-frequency signal and transmitting the high-frequency signal to the communication module 12b for the mobile communication network.

The voice communication module 14c converts a digital voice signal output from the communication interface 13 for the mobile communication network into an analog voice signal, and amplifies and outputs the analog voice signal to the first speaker 14a. An analog voice signal output from the microphone 14b is amplified and converted into a digital voice signal to be transmitted to the communication interface 13 for the mobile communication network.

After amplifying the analog voice signal output from the microphone 14b, the environmental sound analysis module 14d modulates the analog voice signal into a digital voice signal, for example, by PCM modulation, and then obtains a voice frame by dividing the digital voice signal at a predetermined time interval width. The voice frame is applied to, for example, LPC (Linear Predictive Coding) and cepstrum is calculated from spectrum obtained thereby. The cepstrum is stored in the environmental sound storage 24 as a characteristic quantity of the analog voice signal input from the microphone 14b, or is output to the characteristic quantity comparison module 23.

The display unit 15 is, for example, a display unit of an LCD (Liquid Crystal Display), and performs a display operation of prompting a user to make an operation, an operation of displaying contents according to the operation of the user, and an operation of displaying an operating state of the device according to control of the controller 11.

The user interface 16 has alphanumeric keys to be used to input numbers including a telephone number or letters upon mail creation and a plurality of function keys to be used to input an operation instruction of power ON/OFF of the mobile communication device MS and an operation instruction of an outgoing signal transmission/incoming signal reception response, and notifies the controller 11 of a code signal for identifying a key operated by the user according to a start signal from the controller 11.

The near field communication module 17b transmits a near-field wireless signal, received from the near field communication network NW via the antenna 17a, to the near field communication interface 18. A near-field wireless signal output from the near field communication interface 18 is transmitted to the near field communication network NW via the antenna 17a.

When a control signal and a digital voice/audio signal are transmitted to and received from another device, the near field communication interface 18 controls the near field communication module 17b to establish a wireless link on the near field communication network NW. When the transmission/reception of the control signal and the digital voice/audio signal is terminated, the established wireless link is disconnected by the near field communication module 17b under the control of the near field communication interface 18.

A control signal and a digital voice/audio signal are transmitted and received by executing an HFP (Hands-Free Profile) on the established wireless link. For example, a control signal of an incoming signal reception notification/response or a digital voice signal by hands-free voice communication is also transmitted and received by executing the HFP.

When the hands-free voice communication is performed, the near field communication interface 18 transmits a control signal obtained from a near-field wireless signal received by the near field communication module 17b to the controller 11, and transmits a digital voice signal to the communication interface 13 for the mobile communication network. On the other hand, the near field communication module 17b is controlled so that a control signal output from the controller 11 or a digital voice signal output from the communication interface 13 for the mobile communication network is transmitted as a near-field wireless signal through the wireless link.

The near field communication interface 18 can transmit a digital audio signal of music contents or multimedia contents to a device connected through the wireless link by executing an A2DP (Advanced Audio Distribution Profile) on the wireless link. In this case, the near field communication interface 18 converts a digital audio signal of music contents output from the content reproduction module 21 into a near-field wireless signal and then controls the near field communication module 17b to transmit the near-field wireless signal through the wireless link.

The near-field wireless signal is a packet of a format defined by Bluetooth®, and has a size of a payload part of the packet divided in a predetermined size, for example, when a digital voice signal is transmitted. The near field communication interface 18 first executes the HFP before the A2DP is executed. For example, when the interruption of an HFP execution request exists even during the A2DP execution, the HFP is executed according to control of the controller 11 by stopping the A2DP execution.

The content reproduction module 21 reproduces music contents or multimedia contents selected by operating a predetermined key of the user interface 16. At this time, the content reproduction module 21 converts a digital audio signal included in the above-described contents into an analog audio signal and then outputs the analog audio signal from the second speaker 21a. The content reproduction module 21 transmits the digital audio signal to the near field communication interface 18 so that the digital audio signal is transmitted through the wireless link. When an application for reproducing contents through the user interface 16 is started, the contents to be reproduced are determined by selecting desired contents from a content list since a list of contents stored in the content storage 22 is displayed on the display unit 15 by the application.

The characteristic quantity comparison module 23 calculates a distance between a characteristic quantity calculated by the environmental sound analysis module 14d and each characteristic quantity stored in the environmental sound storage 24. When one of calculated distances is less than a predetermined threshold, it is determined that the characteristic quantity of the voice signal calculated by the environmental sound analysis module 14d matches a characteristic quantity stored in the environmental sound storage 24. On the other hand, when all calculated distances are greater than the predetermined threshold, it is determined that the calculated characteristic quantity does not match any one of characteristic quantities stored in the environmental sound storage 24.

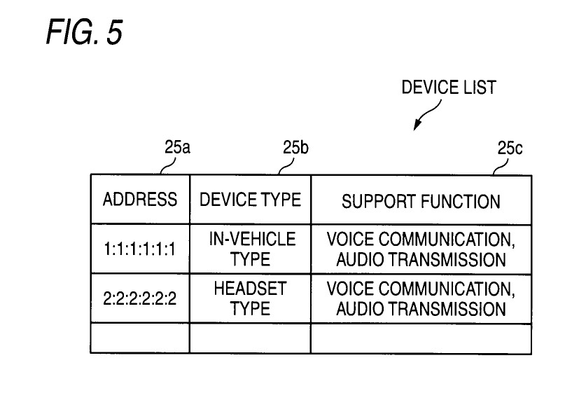

The device list storage 25 stores a device list configured by information for specifying counterpart devices when the near field communication interface 18 performs near field communication through the near field communication network NW. As shown in FIG. 5, the device list has a configuration in which information elements of an address 25a for specifying a counterpart device when near field communication is performed, a device type 25b for identifying a type of counterpart device of “in-vehicle type” or “headset type”, and a support function 25c indicating an executable function of the counterpart device are mapped. In the support function 25c, “voice communication” is registered for the device capable of executing the HFP and “audio transmission” is registered for the device capable of executing the A2DP.

For example, in FIG. 5, a set of an address 25a of “1:1:1:1:1:1”, a device type 25b of “in-vehicle type”, and a support function 25c of “voice communication” and “audio transmission” and a set of an address 25a of “2:2:2:2:2:2”, a device type 25b of “headset type”, and a support function 25c of “voice communication” and “audio transmission” are registered as the device list.

Next, the operation of each element of the headset hands-free device HS will be described with reference to FIG. 3. The near field communication module 32b transmits a near-field wireless signal received from the near field communication network NW to the near field communication interface 33 via the antenna 32a. A near-field wireless signal output from the near field communication interface 33 is transmitted to the antenna 32a. Here, a near field communication scheme is the same as described with reference to the near field communication module 17b.

When a control signal and a digital voice/audio signal are transmitted to and received from the mobile communication device MS, the near field communication interface 33 controls the near field communication module 32b to establish a wireless link on the near field communication network NW.

The near field communication interface 33 performs hands-free voice communication through the mobile communication device MS by executing the HFP on the wireless link. At this time, a control signal extracted from a near-field wireless signal received by the near field communication module 32b is transmitted to the controller 31 and an extracted digital voice signal is transmitted to the codec module 34c. A control signal output from the controller 31 and a digital voice signal output from the codec module 34c are converted into a near-field wireless signal and transmitted to the near field communication module 32b through the wireless link.

The near field communication interface 33 can receive a digital audio signal of music contents or multimedia contents transmitted from the mobile communication device MS by executing the A2DP on the wireless link. Likewise, a digital audio signal extracted from the near-field wireless signal received by the near field communication module 32b is transmitted to the codec module 34c.

The codec module 34c respectively converts the digital voice signal and the digital audio signal received from the near field communication interface 33 into an analog voice signal and an analog audio signal, amplifies the analog signals, and outputs the amplified analog signals through the speaker 34a. An analog voice signal output from the microphone 34b is amplified and converted into a digital voice signal to be transmitted to the near field communication interface 33.

The indicator 35 includes, for example, an LCD, is started from the controller 31, and performs a display operation of prompting a user to make an operation, an operation of displaying contents according to the operation of the user, and an operation of displaying an operating state of the device. Here, the LCD is an illustrative example, but, for example, the same information is converted into a sound signal and output to the codec module 34c, and may be output as “beep” sound information by the speaker 34a.

The user interface 36 has a key for instructing an outgoing call to a counterpart with which the last voice communication was performed, a key for instructing an incoming signal reception response, and a key for instructing power ON/OFF, and notifies the controller 31 of a code signal for identifying each key operated by the user.

Next, the operation of each element of the in-vehicle hands-free device HF will be described with reference to FIG. 4. Since the near field communication module 42b, the near field communication interface 43, and the user interface 46 perform the same operations as the near field communication module 32b, the near field communication interface 33, and the user interface 36 of the headset hands-free device HS, description of their operations is omitted.

The voice communication module 44c converts a digital voice signal output from the near field communication interface 43 into an analog voice signal, amplifies the analog voice signal, and outputs the amplified analog voice signal to the speaker 44a. An analog voice signal output from the microphone 44b is amplified and converted into a digital voice signal to be transmitted to the near field communication interface 43. A digital audio signal received from the content reproduction module 47 is converted into an analog audio signal to be transmitted to the speaker 44a.

The display unit 45 is, for example, an LCD, and performs a display operation of prompting a user to make an operation, an operation of displaying contents according to the operation of the user, and an operation of displaying an operating state of the device according to control of a controller 41.

The content reproduction module 47 reproduces music contents or multimedia contents selected by operating a predetermined key of the user interface 46. The music contents or multimedia contents selected by operating the predetermined key of the user interface 46 are read from the content storage 48, and a digital audio signal included in the read music contents or multimedia contents is output to the voice communication module 44c.

The HFP or A2DP execution by the near field communication interface 43 is first performed before a content reproduction operation of the content reproduction module 47 is performed. That is, when the profile starts to be operated by the near field communication interface 43 during the operation of the content reproduction module 47, the operation of the content reproduction module 47 is stopped by the controller 41.

The voice communication module 44c may have an echo cancellation function for preventing howling when a voice signal output and an audio signal from the speaker 44a are input from the microphone 44b.

A near field communication control operation in the hands-free voice communication system configured as described above according to an embodiment of the present invention will be described.

Device List Storage Process

When a device list update instruction is input according to a predetermined key operation of the user interface 16, the controller 11 starts a process of updating a device list and storing the device list in the device list storage 25. At this time, the in-vehicle hands-free device HF or the headset hands-free device HS is powered on, and the transmission/reception of a near-field wireless signal to/from the mobile communication device MS is not interfered with.

The controller 11 controls the near field communication interface 18 so that the near field communication module 17b receives a near-field wireless signal from the near field communication network NW. The near-field wireless signal includes an address (device address) of a device (the in-vehicle hands-free device HF or the headset hands-free device HS) and a device class of a car audio/headset. Next, when asking for a name on the basis of the device address, device identification information, for example, a friendly name, is included. Next, by asking for an executable profile on the basis of the device address, the HFP or A2DP is obtained. In this process, a predetermined authentication procedure specified by Bluetooth® may be generated.

The controller 11 causes the display unit 15 to display an address of a device transmitting a received near-field wireless signal and/or device identification information, and waits for the displayed address or the device type of “in-vehicle type” or “headset type”, which is identified by the identification information, to be selected according to a predetermined key operation of the user interface 16. The device type may be set by automatic identification on the basis of the obtained device class. When the device type is selected, the address is registered in the address 25a and the selected type is registered in the device type 25b.

When the HFP is included in an executable profile extracted from the received near-field wireless signal, “voice communication” is registered in the support function 25c. When the A2DP is included, “audio transmission” is registered in the support function 25c. The process is terminated by storing the updated and registered device list as described above in the device list storage 25.

Taking a series of procedures of the process of storing the device list as an example, the sequence is random, and a preset value may be registered without requesting an input for the device type 25b. During a procedure of a predetermined HFP and A2DP connection of a portable telephone (not shown), a device list may be generated in the step in which the address 25a and profile information have been recognized.

Process Upon Receipt of an Incoming Signal

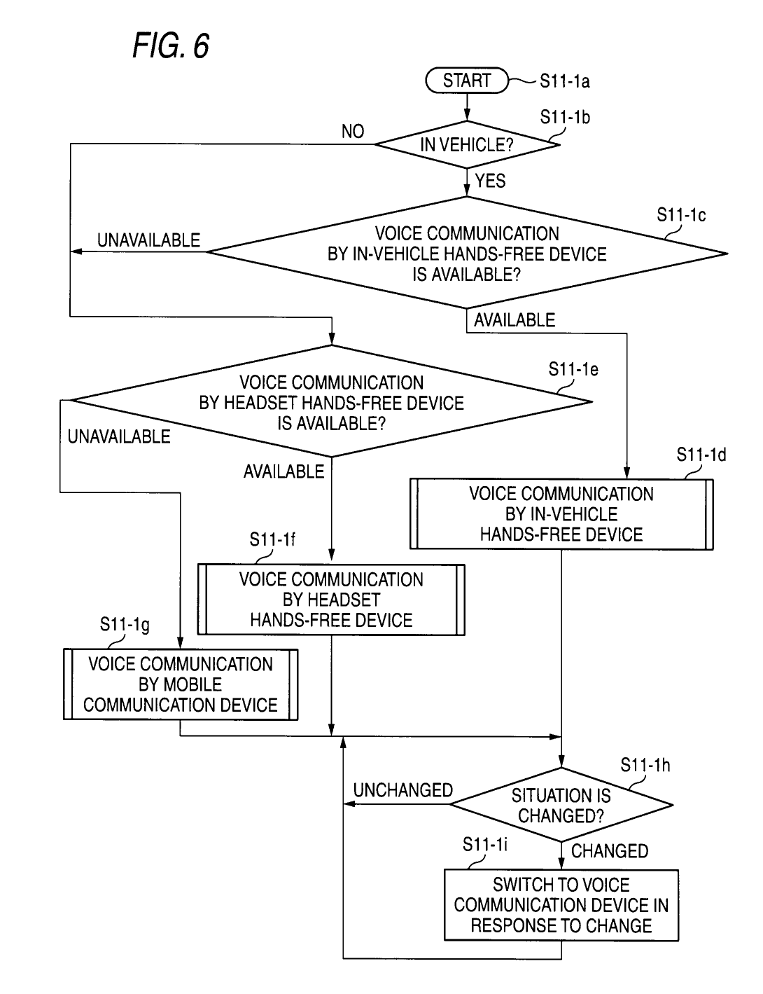

FIG. 6 is a flowchart showing an incoming signal control process executed by the controller 11 and the near field communication control function 11-1 when an incoming signal is sent to the controller 11.

The near field communication control function 11-1 starts a process when an incoming signal is sent to the controller 11 (step S11-1a) and causes the situation inferring function 11-2 to determine whether or not the mobile communication device MS is in the car (step S11-1b).

In this determination, the situation inferring function 11-2 controls the power to be supplied for the environmental sound analysis module 14d and the characteristic quantity comparison module 23, first instructs the environmental sound analysis module 14d to calculate a characteristic quantity on the basis of an analog voice signal input from the microphone 14b, and subsequently instructs the characteristic quantity comparison module 23 to compare the calculated characteristic quantity with a characteristic quantity stored in the environmental sound storage 24 when the characteristic quantity is calculated.

When the instruction exists, the characteristic quantity comparison module 23 compares the characteristic quantity calculated by the environmental sound analysis module 14d with each characteristic quantity stored in the environmental sound storage 24, calculates a distance therebetween, compares the calculated distance with a predetermined threshold, and determines whether or not the characteristic quantity calculated by the environmental sound analysis module 14d matches any one of the characteristic quantities stored in the environmental sound storage 24.

According to the match or mismatch as the comparison result of the characteristic quantity comparison module 23, the situation inferring function 11-2 determines whether or not the mobile communication device MS is in the car.

When it is determined that the mobile communication device MS is in the car according to the match as the comparison result in step S11-1b, the near field communication control function 11-1 controls power to be supplied for the near field communication module 17b and the near field communication interface 18 and then determines whether or not hands-free voice communication using a near-field wireless link by the in-vehicle hands-free device HF is available (step S11-1c).

That is, on the basis of the device list stored in the device list storage 25, a device of “in-vehicle type” registered in the device type 25b and “voice communication” registered in the support function 25c is extracted. An address of the extracted device is read from the address 25a. When the near field communication interface 18 can establish the wireless link on the near field communication network NW using the address, the near field communication control function 11-1 determines that near-field radio voice communication is available.

Since a wireless environment may be unstable and a wireless link may not be temporarily established, the wireless link establishment is not used as a criterion of determining whether or not near-field radio voice communication is available. When a near-field wireless signal can be received from the device having the read address, it can be determined that the near field communication is available.

In the case where it is determined that voice communication by the in-vehicle hands-free device HF is available, the near field communication control function 11-1 controls the near field communication interface 18 to execute the HFP, notifies the in-vehicle hands-free device HF of the incoming signal reception, and perform voice communication by the in-vehicle hands-free device HF when a response instruction by an operation of the user interface 46 to the notification is input (step S11-1d).

On the other hand, in the case where it is determined that voice communication by the in-vehicle hands-free device HF is unavailable (including the case where no connectable in-vehicle hands-free device HF exists in the device list of the device list storage 25) in step S11-1c, or in the case where it is determined that no mobile communication device MS exists in the car in step S11-1b, the near field communication control function 11-1 checks whether or not voice communication by the headset hands-free device HS is available (step S11-1e).

That is, the near field communication control function 11-1 continuously supplies power to the near field communication module 17b and the near field communication interface 18 and identifies whether the device type 25b of “headset type” and the support function 25c of “voice communication” exist from the device list of the device list storage 25. If so, a near field communication address corresponding to “headset type” and “voice communication” is read from the address 25a. When the near field communication interface 18 can establish the wireless link using the address, the near field communication control function 11-1 determines that the above-described voice communication is available. When a near-field wireless signal can be received from a device having the read address as described above, it may be determined that the near field communication is available.

When it is determined that voice communication by the headset hands-free device HS is available, the near field communication control function 11-1 controls the near field communication interface 18 to execute the HFP and notifies the headset hands-free device HS of incoming

When a response instruction by an operation of the user interface 36 for the notification is input, hands-free voice communication is performed using the headset hands-free device HS (step S11-1f).

On the other hand, in the case where it is determined that voice communication by the headset hands-free device HS is also unavailable (including the case where no connectable headset hands-free device HS exists in the device list of the device list storage 25), the near field communication control function 11-1 notifies the controller 11 that hands-free voice communication is unavailable, and stops power supply for the near field communication module 17b and the near field communication interface 18. Upon receipt of the notification that the hands-free voice communication is unavailable, the controller 11 causes the display unit 15 of the mobile communication device MS to make the notification of the incoming signal reception, and enables the voice communication to be performed when the user interface 16 is operated and an instruction is input in response to the incoming signal reception during the notification of the incoming signal reception (step S11-1g).

In this regard, in the case of determining that the mobile communication terminal MS is in the car in step S11-1b, since it is estimated that the car is being driven, it is preferable that, without the notification of incoming signal reception, the controller 11 send a message indicating a situation where the voice communication is unavailable to a calling communication terminal, or start a recording function during the absence so that the counterpart leaves a message.

When the mobile communication device MS attempts to access the in-vehicle hands-free device HF or the headset hands-free device HS, and, for example, when the in-vehicle hands-free device HF or the headset hands-free device HS is connected to another mobile communication device MS or access is not prepared since a start process is in operation immediately after the in-vehicle hands-free device HF or the headset hands-free device HS is powered on, the access may fail.

When the reason for the access failure is obvious, it is preferable to re-establish access or waits for the in-vehicle hands-free device HF or the headset hands-free device HS to have access without stopping the power supply for the near field communication module 17b and the near field communication interface 18. For this case, in the mobile communication device MS, setting information regarding the wait for the hands-free voice communication device to have access may be retained in advance without stopping the power supply, besides that the power supply is stopped when a connection is not established.

For example, when all the setting information of the wireless communication device MS is cleared, the in-vehicle hands-free device HF or the headset hands-free device HS of an access point may not be determined since a device address of the in-vehicle hands-free device HF or the headset hands-free device HS of the access point is not received in advance. However, in consideration of a situation where the in-vehicle hands-free device HF or the headset hands-free device HS knows the address 25a of the wireless communication device MS, it may be set to wait for the in-vehicle hands-free device HF or the headset hands-free device HS to have access without accessing the in-vehicle hands-free device HF or the headset hands-free device HS in step S11-1c or S11-1e.

On the other hand, after hands-free voice communication using the in-vehicle hands-free device HF or the headset hands-free device HS is started, the near field communication control function 11-1 monitors whether a wireless link has been disconnected (step S11-1h).

A change in the situation does not include a change in a result of determination performed in step S11-1b. This is because it is difficult to determine whether or not the mobile communication device MS is in the car by comparing a characteristic quantity, based on sound in which the voice and engine operating sound are mixed, with a characteristic quantity of a voice signal stored in the environmental sound storage 24 since voice based on voice communication is input from the microphone 14b during the voice communication even though there is no voice communication by the mobile communication device MS. However, when this determination is available, the situation change may include the change in the result of determination performed in step S11-1b.

Without the use of the change in the result of determination performed in step S11-1b, it is available to detect whether or not the mobile communication device MS is in the car using a change in a result of determining whether or not voice communication by the in-vehicle hands-free device HF is available in step S11-1c.

On the other hand, when the situation has been changed, the near field communication control function 11-1 makes the determinations of steps S11-1c and S11-1e. As a result, voice communication is switched to hands-free voice communication by the in-vehicle hands-free device HF in step S11-1d, hands-free voice communication by the headset hands-free device HS in step S11-1f, or voice communication by the mobile communication device MS in step S1-1g (511-1i), and then the transition to an operation of determining whether or not the situation has been changed in step S11-1h is made.

For example, specifically, when a link with various hands-free voice communication devices is disconnected while voice communication is performed using the mobile communication device MS during a stop state, it is preferable to stop power supply for the near field communication module 17b and the near field communication interface 18 since it is considered that the user is obviously aware of the disconnection and that the connection to the hands-free voice communication device is not made.

In the case where a link is abnormally disconnected while communication is performed using various hands-free voice communication devices, this is an operation unintended by the user. In this case, since it is undesirable that voice communication is continued and voice communication fees are charged, it is preferable to terminate voice communication when the link cannot be recovered within a predetermined time interval.

When the link is normally disconnected while voice communication is performed using various hands-free voice communication devices before a change to voice communication by the mobile communication device MS is made, it is preferable to make a determination starting from S11-1c since it is considered that the user has intended to exit the car by normally stopping the engine and to attempt battery conservation by normally stopping the headset. Since the user's intention for the normal disconnection is not obvious, voice communication may be terminated as in the abnormal disconnection.

It is enough to perform an operation of determining whether or not the situation has been changed in step S11-1h at a predetermined time interval, for example, at an interval of several seconds. Alternatively, when a change is made to disconnect a link established on the near field communication network NW, it is preferable to directly switch to another device so as to smoothly continue voice communication. Thus, when the link is disconnected, it is appropriate to start the determination operation by interruption from the near field communication interface 18. For example, during the hands-free voice communication by the in-vehicle hands-free device HF, this situation change occurs when the engine of the car in which the device is installed is stopped and when the mobile communication device MS is far away from the car.

Whenever voice communication is terminated regardless of the operation step, the near field communication control function 11-1 terminates a control operation (which is not shown), and stops the power supply for the near field communication module 17b and the near field communication interface 18 in the case where hands-free voice communication is performed.

Among the above-described control operations of the near field communication control function 11-1 upon receipt of an incoming signal, an operation of causing the situation inferring function 11-2 to determine whether or not the mobile communication device MS is in the car in step S11-1b is similar to an operation of checking whether or not voice communication by the in-vehicle hands-free device HF is available in step S11-1c, and may be omitted. However, when the mobile communication device MS exits and is still located near the car whose engine is running, the hands-free voice communication by the in-vehicle hands-free device HF in step S11-1d can be disabled by causing the situation inferring function 11-2 to perform the determination operation.

In the above description, when the hands-free voice communication by any one of the in-vehicle hands-free device HF and the headset hands-free device HS is available, the near field communication control function 11-1 controls an operation of performing the hands-free voice communication by the in-vehicle hands-free device HF. This is because it is appropriate to perform in-vehicle voice communication by the in-vehicle hands-free device HF designed for voice communication. It is not limited thereto and the hands-free voice communication may be performed by the headset hands-free device HS. Thereby, the user of the mobile communication device MS can perform voice communication by the headset hands-free device HS according to preference.

In the above description, when a device list related to a plurality of in-vehicle hands-free devices is provided in step S11-1c, all the devices attempt to perform the hands-free voice communication of step S1′-1d. As a result, the voice communication with one in-vehicle hands-free device is available without any difficulty. This is because a situation where the user of the mobile communication device MS is present within a plurality of cars does not occur.

Likewise, when a device list related to a plurality of headset hands-free voice communication devices is provided in step S11-1e, all the devices attempt to perform the hands-free voice communication of step S11-1f. As a result, the voice communication with one headset hands-free device is available without any difficulty. This is because a situation where the user of the mobile communication device MS applies power to the plurality of headset hands-free devices does not occur.

The mobile communication device MS can have an acceleration sensor in addition to the characteristic quantity comparison module 23 or in place thereof. In this case, the acceleration sensor detects an acceleration value at predetermined timing of a given period or the like, and the acceleration value is stored in an acceleration value storage (not shown). On the other hand, the situation inferring function 11-2 determines whether a person holding the mobile communication device MS is standing, walking, or moving by car or electric train, from a change of an acceleration value stored in the acceleration value storage.

For example, it is determined whether or not the mobile communication device MS exists in the car using an evaluation result determining existence in a car or an electric train provided by the situation inferring function 11-2 in addition to an evaluation result determining existence in the car provided by the situation characteristic quantity comparison module 23. Upon receipt of an incoming signal, it may be determined whether to transmit the incoming signal to the in-vehicle hands-free device HF or the headset hands-free device HS on the basis of the determination result.

In this case, a database in which change amounts of an acceleration value are mapped to a standing situation, a walking situation, and situations in the car and the electric train is retained in the acceleration value storage. The situation inferring function 11-2 estimates the situation of the mobile communication device MS from a detected change amount of the acceleration value.

When it is difficult to determine whether the device is moving by car or electric train on the basis of an acceleration value detected by the acceleration sensor, a high-precision situation determination is available by acquiring position information using a GPS sensor (not shown), comparing the acquired position with map data, and determining that the device is moving by car on a road or moving by electric train on a railway line.

Of course, it can be determined whether or not the mobile communication device MS is in the car using only the determination result of the situation inferring function 11-2 based on the acceleration value without using both the determination result of the characteristic quantity comparison module 23 and the determination result of the situation inferring function 11-2 based on the acceleration value.

Like the power supply for the characteristic quantity comparison module 23, the power supply for the acceleration sensor is controlled by the situation inferring function 11-2.

Operation Upon Signal Transmission

When voice communication by the communication interface 13 for the mobile communication network is not made, the near field communication control function 11-1 performs a control operation of near field communication based on an operation of a predetermined key instructing the voice communication start in the user interface 16. Since this control operation is the same as the control operation in the case where the above-described incoming signal is sent to the controller 11, its description is omitted. During this control operation, voice communication includes an outgoing call operation.

In this regard, since the signal transmission operation of the mobile communication device MS may also be considered as the intention for voice communication by the mobile communication device MS, setting in which this operation is performed or not performed by presetting of the mobile communication device MS is retained and an operation based on this setting may be performed.

Operation Upon Start of Content Reproduction

When the reproduction of music contents or multimedia contents is started by the content reproduction module 21 on the basis of an operation of a predetermined key of the user interface 16, the near field communication control function 11-1 performs a control operation for near field communication. This control operation is the same as that in the above-described case where the incoming signal is sent to the controller 11, and its description is omitted.

In this operation, a determination of whether or not “voice communication” is included in the support function 25c in steps S11-1c and S11-1e may be replaced with that of whether or not “audio transmission” is included. Hands-free voice communication by the in-vehicle hands-free device HF according to the HFP in step S11-1d may be replaced with transmission of a digital audio signal of music contents to the in-vehicle hands-free device HF according to the A2DP.

Hands-free voice communication by the headset hands-free device HS according to the HFP in step S11-1f may be replaced with transmission of a voice signal or a digital audio signal of music contents or multimedia contents to the headset hands-free device HS according to the A2DP. Voice communication by the mobile communication device MS in step S11-1g may be replaced with generation of a voice signal or a digital audio signal of music contents or multimedia contents by the second speaker 21a.

In the above description, when incoming signal information is received through the mobile communication network and the mobile communication device MS after a wireless link is established with the mobile communication device MS through the near field communication network NW upon starting hands-free voice communication, the in-vehicle hands-free device HF and the headset hands-free device HS report the incoming signal reception. After the in-vehicle hands-free device HF and the headset hands-free device MS automatically or manually perform a procedure of responding to the incoming signal, hands-free voice communication with another communication device may be started.

For authentication in communication through the near field communication network NW, a device list stored in the device list storage 25 provided in the mobile communication device MS in the above description is used, but it is not limited thereto. For example, the authentication may not be generated at a timing shown in the device list storage process, and a predetermined authentication procedure defined by Bluetooth® may be generated at an arbitrary timing. The device list may be stored in the in-vehicle hands-free device HF and/or the headset hands-free device HS.

The device list includes a link key as key information defined by Bluetooth®, and the wireless link may be established by performing the authentication procedure by a predetermined procedure defined by Bluetooth®. Whenever a new device list is stored, the link key is generated by the user inputting the same passkey from each of the user interfaces of the two devices.

In the above description, environmental sound stored in the environmental sound storage 24 is a characteristic quantity of voice (considering engine operating sound) in one car. This is because it has been assumed that the number of cars which the user of the mobile communication device MS gets into and in which hands-free voice communication by the in-vehicle hands-free device HF is performed is one. However, it is not limited thereto.

For example, a characteristic quantity of sound, in the car where the in-vehicle hands-free device HF identified by the address 25a is installed, mapped to the address 25a may be stored as the device list. Here, the device type 25b mapped to the address 25a is “in-vehicle type”.

As described in the above, there is provided a mobile communication device that is capable of performing near field communication when the near field communication is required.

Although the embodiment according to the present invention has been described above, the present invention is not limited to the above-mentioned embodiment but can be variously modified.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile communication device comprising:
a first communication module configured to perform first wireless communication with a base station;
a second communication module configured to perform second wireless communication with a hands-free device through a near field communication network;
a power controller configured to supply power to the second communication module when an incoming signal is received from the base station; and
a link controller configured to control the second communication module to establish a wireless link with the hands-free device after the power is supplied to the second communication module by the power controller,
wherein the power controller maintains supplying the power to the second communication module when the wireless link is established by the link controller and stops supplying the power to the second communication module when the wireless link is unestablished by the link controller.

2. The mobile communication device of claim 1 further comprising:
a characteristic quantity storage configured to store a first characteristic quantity indicating that the incoming signal should preferably be transmitted to the hands-free device;
a characteristic quantity calculation module configured to calculate a second characteristic quantity from input ambient sound; and
a characteristic quantity comparison module configured to compare the second characteristic quantity with the first characteristic quantity.

3. The mobile communication device of claim 2, wherein the power controller supplies the power to the characteristic quantity calculation module and the characteristic quantity comparison module when the incoming signal is received from the base station, wherein the characteristic quantity calculation module calculates the second characteristic quantity from the ambient sound when the power is supplied,
wherein the characteristic quantity comparison module notifies the power controller a determination result indicating whether or not the second characteristic quantity matches the first characteristic quantity, and
wherein the power controller supplies the power to the second communication module upon receipt of the notification indicating that the second characteristic quantity matches the first characteristic quantity.

4. The mobile communication device of claim 3, wherein the first characteristic quantity stored in the characteristic quantity storage is a measured characteristic quantity that is measured when the mobile communication device exists in a vehicle and while no voice communication is performed.

5. The mobile communication device of claim 3, wherein the power controller stops supplying the power to the characteristic quantity calculation module and the characteristic quantity comparison module when comparing the second characteristic quantity with the first characteristic quantity is finished.

6. A mobile communication device comprising:
a first communication module configured to perform first wireless communication with a base station;
a second communication module configured to perform second wireless communication with a first hands-free device and a second hands-free device through a near field communication network;
a link controller configured to control the second communication module to establish a wireless link with one of the first hands-free device and the second hands-free device;
a characteristic quantity storage configured to store a first characteristic quantity indicating that the incoming signal should preferably be transmitted to the first hands-free device;
a characteristic quantity calculation module configured to calculate a second characteristic quantity from input ambient sound;
a characteristic quantity comparison module configured to compare the second characteristic quantity with the first characteristic quantity; and
a power controller configured to supply power to the characteristic quantity calculation module, the characteristic quantity comparison module, and the second communication module upon receipt of the incoming signal from the base station.

7. The mobile communication device of claim 6, wherein the characteristic quantity calculation module and the characteristic quantity comparison module calculates the second characteristic quantity from the ambient sound and determines whether the second characteristic quantity matches with the first characteristic quantity when the power is supplied upon receipt of the incoming signal,
wherein the link controller controls the second communication module to establish the wireless link with the first hands-free device when determined that the second characteristic quantity matches with the first characteristic quantity and controls the second communication module to establish the wireless link with the second hands-free device when determined that the second characteristic quantity does not match with the first characteristic quantity, and
wherein the power controller maintains supplying the power to the second communication module when the wireless link is established by the link controller and stops supplying the power to the second communication module when the wireless link is unestablished by the link controller.

8. The mobile communication device of claim 7, wherein the first characteristic quantity stored in the characteristic quantity storage is a measured characteristic quantity that is measured when the mobile communication device exists in a vehicle and while no voice communication is performed.

9. The mobile communication device of claim 7, wherein the power controller stops supplying the power to the characteristic quantity calculation module and the characteristic quantity comparison module when comparing the second characteristic quantity with the first characteristic quantity is finished.

10. A method for controlling a mobile communication device comprising:
a first communication module configured to perform first wireless communication with a base station; and
a second communication module configured to perform second wireless communication with a hands-free device through a near field communication network,
wherein the method comprises:
supplying power to the second communication module when an incoming signal is received from the base station;
controlling the second communication module to establish a wireless link with the hands-free device after the power is supplied to the second communication module;
controlling to maintain supplying the power to the second communication module when the wireless link is established and to stop supplying the power to the second communication module when the wireless link is unestablished.

11. The method of claim 10 further comprising:
storing a first characteristic quantity indicating that the incoming signal should preferably be transmitted to the hands-free device;
calculating a second characteristic quantity from input ambient sound; and
comparing the second characteristic quantity with the first characteristic quantity.

12. The method of claim 11, wherein the power is supplied for calculating the second characteristic quantity and for comparing the second characteristic quantity with the first characteristic quantity when the incoming signal is received from the base station,
wherein the second characteristic quantity is calculated from the ambient sound when the power is supplied, and
wherein the power is supplied to the second communication module upon receipt of a notification indicating that the second characteristic quantity matches the first characteristic quantity.

13. The method of claim 12, wherein the first characteristic quantity being stored is a measured characteristic quantity that is measured when the mobile communication device exists in a vehicle and while no voice communication is performed.

14. The method of claim 12, wherein the power supplied for calculating the second characteristic quantity and for comparing the second characteristic quantity with the first characteristic quantity is stopped when comparing the second characteristic quantity with the first characteristic quantity is finished.
